(19) United States
(12) Patent Application Publication
(10) Pub. No.: US 2009/0278996 A1
(43) Pub. Date: Nov. 12, 2009

(54) Method and system for selecting a broadcast-signal in a multi-user environment

(75) Inventor: José Manuel Herrera Van Der Nood, Hellevoetsluis (NL)

Correspondence Address: MICHAELSON & ASSOCIATES, P.O. BOX 8489, RED BANK, NJ, 07701-8489, US

(73) Assignee: KONINKLIJKE KPN N.V. The Hague, The Netherlands

(21) Appl. No.: 12/448,446

(22) PCT Filed: Dec. 6, 2007
(86) PCT No.: PCT/EP2007/010579

§ 371 Date: Jun. 19, 2009

Related U.S. Application Data
(60) Provisional application No. 60/876,874, filed on Dec. 22, 2006.

(51) Int. Cl. H04N 5/50

(52) U.S. Cl. 348/731

(57) ABSTRACT

There is disclosed a system comprising, a source-tuner having a receiver for receiving external broadcast-signals, and a transmitter for broadcasting internal broadcast-signals to a network that communicatively links the source-tuner to a number of tuners. The source-tuner is adapted to receive control-signals from the tuners and to select external broadcast-signals as the source of the internal broadcast-signals, on the basis of the control-signal received from the tuner.

### BACKGROUND OF THE INVENTION

### Field of the Invention

The invention relates generally to a source-tuner for use in a broadcast network; a tuner for use in a broadcast network; a system comprising the source-tuner and the tuner communicatively linked via a network; and a method of selecting a broadcast-signal, in such a system.

The invention particularly relates to broadcast networks on which streaming media are transmitted.

### BRIEF SUMMARY OF THE INVENTION

A system used to transmit streaming media (for example video, audio, television, radio, music) to multiple end-receivers (for example, televisions, multimedia software on computers, radios, consumer devices, multi-media devices and set-top boxes) is provided. The system comprises a network with multiple tuners connected thereto. Each of the tuners receives a broadcast-signal from the network and forwards the signal, with appropriate signal transformation if necessary, to an end-receiver associated with it.

Such a system is also provided with a source-tuner. The source-tuner carries out the function of broadcasting the broadcast-signal to the network. The source-tuner does this by receiving an external broadcast-signal from an origin which is external to the network, and forwarding the signal as an internal broadcast-signal to the network.

The forwarding of the broadcast-signal may either be by direct broadcast of the external broadcast-signal as received or may involve transformation of the signal into other formats, for example transformation from an external DVB-H signal to an internet protocol signal.

The external origin of the broadcast-signal may be any number of sources. The invention is particularly suitable for use where the external broadcast-signal is a television signal (analogue, digital, satellite, internet protocol, DVB-T, DVB-H, or the like); videotape recorder; DVD player/recorder; computer; or similar media signals. The invention is more preferably used in combination with wireless external broadcast-signals and most preferably with DVB-H external broadcast-signals.

The source-tuner will typically receive a number of external broadcast-signals, either from a single source or multiple sources, from which it is able to select a signal or a plurality of signals for forwarding on to the network as an internal broadcast-signal or a number of internal broadcast-signals. The source-tuner is able to switch from a currently selected broadcast-signal to an alternative broadcast-signal so as to change the internal broadcast-signal on the network (for example, for the function of switching from one television channel to another).

Changing broadcast signal, that is switching from one selected broadcast-signal to another, by the source-tuner can be initiated by local interaction with the source-tuner, for example, by using a remote control that sends a control-signal directly to the source-tuner, by using a remote control that sends a control-signal to an end-receiver which forwards the control-signal to the connected source-tuner, by pressing a button directly on the source-tuner resulting in a control-signal, by pressing a button on an end-receiver resulting in a control-signal which is forwarded to the connected source-tuner, by using a software program on a PC that generates a control-signal which is forwarded to the connected source-tuner, or similar methods. The control-signal is processed by the source-tuner, resulting in the source-tuner changing the broadcast-signal (e.g., by selecting another video, tuning to another television channel, tuning to another radio channel, etc.).

According to one aspect of the present invention there is provided a source-tuner comprising; a receiver for receiving an external broadcast-signal; and a transmitter for broadcasting an internal broadcast-signal to a network communicatively linked to a tuner. The source-tuner is adapted to receive a control-signal from the tuner and to select an external broadcast-signal, as the source of the internal broadcast-signal, on the basis of the control-signal received from the tuner.

According to another aspect of the present invention there is provided a tuner comprising; a receiver for receiving an internal broadcast-signal from a network communicatively linked to a source-tuner; a tuner-transmitter for transmitting a signal to an end-receiver; and a control-signal transmitter for transmitting a control-signal to the source-tuner via the network.

According to another aspect of the invention there is provided a system comprising; a source-tuner as described above; a tuner as described above; and a network communicatively linking the source-tuner and the tuner; said network being capable of transmitting an internal broadcast-signal, preferably a streaming media broadcast-signal.

According to another aspect of the invention there is provided a method of selecting a broadcast-signal in which; one of the tuners sends a control-signal to the source-tuner; and the source-tuner receives the control-signal and selects an external broadcast-signal from a plurality of available external broadcast-signals on the basis of the control-signal. In this relation the control-signal comprises information instructing selection of a particular broadcast-signal.

In such a system it is beneficially possible for a user to switch from one broadcast-signal to another by local interaction with the tuner. This is advantageous because the tuner may be significantly remote from the source-tuner, for example, in a different room of a building.

According to a preferred embodiment of the invention, where a plurality of tuners is provided on the network, a priority level is associated with each of the tuners. In such an embodiment the source-tuner will only carry out the action of selecting an external broadcast-signal in response to a control-signal when the priority level of the tuner transmitting the control-signal meets certain requirements.

For example, a control-signal from a tuner with a lower priority will not be acted upon by the source-tuner to change the selected broadcast-signal if the selection of that broadcast-signal was initiated by another tuner with a higher priority level. A control-signal from a tuner with a higher priority level will be acted on by the source-tuner to change the selected broadcast-signal if selection of that broadcast-signal was initiated by a tuner with a lower priority level. Tuners with the same priority level can change the broadcast-signal if selection of that broadcast-signal was initiated by a tuner with the same priority level. A control-signal from a tuner will effect the changing of the broadcast-signal where the broadcast signal was initiated by the same tuner.

This is preferably achieved by a method in which the source-tuner ascertains the priority level of a tuner sending a control-signal and then compares the priority level of the tuner transmitting the control-signal with the priority level of the tuner which sent a control-signal resulting in selection of the presently selected broadcast-signal.

The source-tuner may be able to ascertain the priority level of the tuner transmitting a control-signal in a number of ways.

The priority level of the tuner transmitting the control-signal may be incorporated as part of the control-signal.

The control-signal may incorporate an identification of the tuner that is transmitting it. In this case the source-tuner comprises a memory containing a list of tuner identifications and priority levels associated with the tuners. On receipt of the control-signal the priority level of the transmitting tuner is retrieved from the list.

In some cases both the priority level and an identification of the transmitting tuner may be incorporated into the control-signal.

The tuner is preferably adapted to transmit a control-signal comprising its identification, its priority level, or both its identification and priority level.

In a preferred embodiment of the invention the source-tuner is provided with memory for storing an identification and/or a priority level of at least one of the tuners. Preferably the memory is adapted to store identifications and/or priority levels of a plurality of tuners.

In an embodiment where the priority level of a tuner is incorporated into its control-signal, the tuner need only store data relating to the priority level of the tuner which initiated the selection of a current broadcast-signal. The priority level of the incoming control-signal is compared to the stored priority level and action taken when the incoming control-signal has the appropriate priority level. The source-tuner is, of course, not restricted to storing only this data.

The priority levels may be assigned to the tuners prior to installation time, at installation time, or after the tuners have been installed.

In a preferred embodiment the tuners in the network make their presence known to the source-tuner by sending a logon signal to the source-tuner when connected to the network. The logon signal comprises at least the priority level and an identification of the tuner. The source-tuner stores the identification and the priority level in memory.

In an alternative embodiment the priority level of each tuner can be assigned by the source-tuner. A priority level does not need to be comprised in the logon signal in this case, or the priority level in the logon signal can be ignored by the source-tuner. The source-tuner can in this alternative assign the priority level in any suitable manner, e.g., by taking into account the order in time of receipt of logon signals, by taking into account predefined priority lists (e.g., based on types of receivers, types of tuners, identification of the tuner, etc.) stored in a memory of the source-tuner.

Preferably, information concerning priority levels and identifications stored in the source tuner and/or tuners can be removed and/or altered. For example, information may be removed from the source tuner when a tuner sends a logoff signal to the source tuner or when the tuner is disconnected from the network.

In the case where the priority levels are assigned by the source-tuner, it is preferably possible to configure or change priority levels stored on the source-tuner.

In a preferred embodiment the source-tuner generates status information that can be displayed on one or more end-receivers. The status information can be transmitted from the source-tuner to tuners connected to the network, which in turn forward the status-information to the end-receivers.

In a preferred embodiment of the invention the source-tuner comprises a status-information generator and status-information transmitter for transmitting the status-information via the network; and the tuner is adapted to incorporate the status-information into a signal which is forwarded to an end-receiver communicatively linked to it.

The status-information can comprise one or more of the following information items:
overview of available broadcast-signals;
additional information about the available broadcast-signals;
overview of tuners connected to the source-tuner;
overview of end-receivers connected to tuners connected to the source-tuner;
tuners and/or end-receivers that are currently receiving a broadcast-signal;
tuner and/or end-receiver that initiated the latest change in a broadcast-signal;
whether or not it is possible to change a broadcast-signal for a particular tuner and/or end-receiver (i.e., does the priority level allow change of broadcast-signal);
availability of broadcast-signals (in case there are two or more broadcast-signals); or
availability of source-tuners (in case there are two or more source-tuners connected to the network);

It is possible that more than one broadcast-signal is available on the network, and the source-tuner is capable of changing two or more broadcast-signals. In that case it is possible that the invention is used for each available broadcast-signal. It is also possible that there are two or more source-tuners in the network, in which case the invention is applicable to each of the source-tuners. With multiple source-tuners connected to a network, it is possible that one or more source-tuners also act as a ‘normal’ tuner, i.e., a non-source-tuner.

### BRIEF DESCRIPTION OF THE DRAWINGS

The invention will be explained in greater detail by reference to exemplary embodiments shown in the drawings, in which:

FIG. 1 shows a network with tuners and receivers according to an exemplary embodiment of the invention;

FIG. 2 shows a schematic of a source-tuner; and

FIG. 3 shows a schematic of a tuner.

### DESCRIPTION OF ILLUSTRATIVE EMBODIMENTS

For the purpose of teaching of the invention, preferred embodiments of the method and system of the invention are described in the sequel.

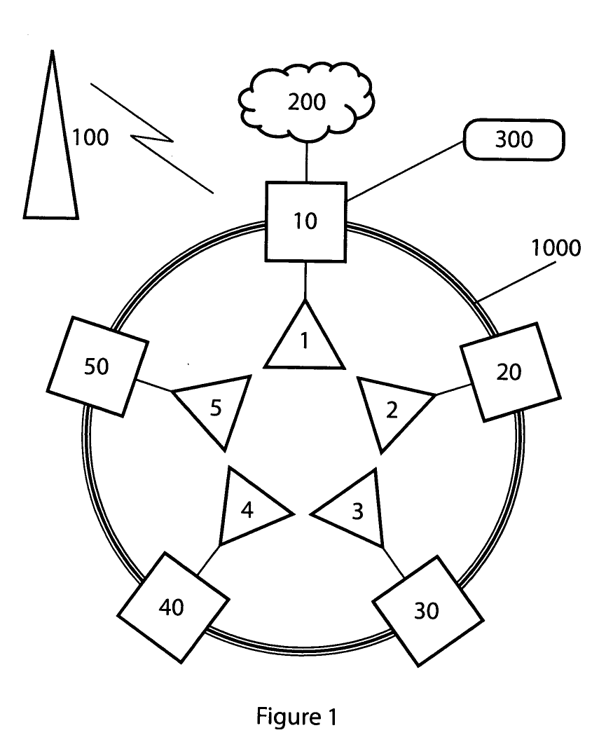

FIG. 1 shows an embodiment of the invention where multiple tuners (10, 20, 30, 40, 50) are connected to one network (1000), which network is used to transmit a broadcast-signal to the tuners. Each tuner picks up the broadcast-signal and forwards the signal to an end-receiver (1, 2, 3, 4, 5) connected to the tuner. The broadcast-signal is used to transmit any kind of streaming media, like video, audio, television, radio, music, and similar media. Examples of end-receivers are televisions, multimedia software on PCs, radios, and the like. The network is typically an in-house network, but it can also be an in-room network, a company network, or the like. The network is capable of transmitting streaming media. An IP (Internet Protocol) based network using Ethernet/LAN, wireless-LAN and/or Bluetooth is an example of a capable network.

One of the tuners operates as a source of the broadcast-signal on the network. From this source-tuner (10) the broadcast-signal (internal broadcast-signal) is broadcast onto the network and the other tuners (20, 30, 40, 50) on the network receive this signal to be forwarded to the connected end-receiver (2, 3, 4, 5). If the source-tuner changes the broadcast-signal (that is, selects an alternative broadcast-signal to the currently selected one), e.g., by changing from one video to another video, then the other tuners on the network will receive the new broadcast-signal. If, for example, 1 is a TV, 2 is a PC, 3 is a radio, 4 is a notebook and 5 is a TV, then this has the effect that all people watching the video on, e.g., TV 1, TV 5 and laptop 4 will see the video change when the source-tuner changes the video.

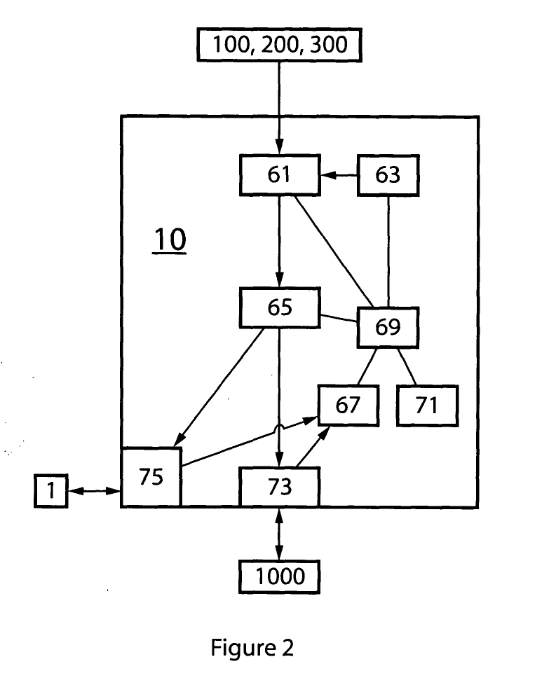

The source-tuner (10), as illustrated in FIG. 2, is provided with a receiver (61) for receiving an external broadcast signal (100, 200, 300); a tuner (63) for tuning the receiver (61) to receive a particular external broadcast-signal; a translator (65) for transforming the external broadcast-signal into a format suitable for broadcast on the network (1000); a control-signal receiver (67); a central processor (69) to control the various components; memory (71); an end-receiver communication port (75) for receipt of signals and transmission of signals to the directly linked end-receiver (1); and a network communication port (73) for receipt of signals from and transmission of signals to the network (1000).

In an alternative embodiment where the external broadcast-signal is already in a format suitable for transmission on the network (1000), the translator (65) need not be provided.

In another alternative embodiment, the source-tuner is not provided with an end-receiver communication port (75) and no end-receiver is directly linked to the source-tuner (10).

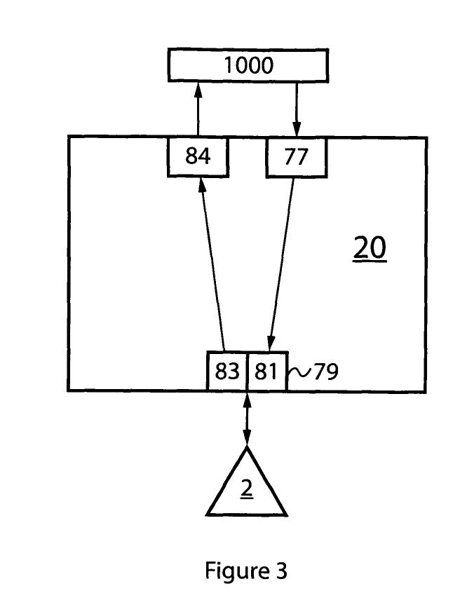

A tuner (20) is illustrated in FIG. 3. The tuner (20) is provided with a receiver (77) for receiving an internal broadcast-signal from the network (1000); an end-receiver communication port (79); and a control-signal transmitter (84) for transmitting a control-signal to the source-tuner (10) via the network (1000). The end-receiver communication port comprises a tuner transmitter (81) for transmitting a signal to the end receiver (2), and a control-signal receiver (83) for receiving and forwarding a control-signal to the control-signal transmitter (84).

The signal that is broadcast by the source-tuner (10) can originate from different origins (100, 200, 300). The origin can, for example, be an external television signal (analogue television, digital television, IP television, television signal received by satellite dish, DVB-T, DVB-H, etc.), video recorder, DVD player, hard disk recorder, PC, or the like. In FIG. 1, for example, 100 is a DVB-H origin, 200 is an IP television origin, and/or 300 is a video recorder.

Changing the broadcast-signal, that is switching from a selected broadcast signal to an alternative broadcast signal, can be initiated in any known way, e.g., by using a remote control that sends a control-signal directly to the source-tuner, by pressing a button directly on the source-tuner resulting in a control-signal, or similar methods. The control-signal is processed by the source-tuner, resulting in the source-tuner changing the broadcast-signal (e.g., by selecting another video, tuning to another television channel, tuning to another radio channel, etc.).

Instead of initiating a change of broadcast-signal using the source-tuner as described above, changing the broadcast-signal can also be initiated using another tuner (20, 30, 40, 50) in the network not being the source-tuner (10). The control-signal is then sent from the tuner that receives the control-signal to the source-tuner using the network. This can be initiated for example by using a remote control that sends a control-signal to an end-receiver which forwards the control-signal via a tuner to the connected source-tuner, by pressing a button on the end-receiver resulting in a control-signal which is forwarded via a tuner to the connected source-tuner, by using a software program on a PC that generates a control-signal which is forwarded via a tuner to the connected source-tuner, or similar methods. The control-signal is processed by the source-tuner, resulting in the source-tuner changing the broadcast-signal (e.g., by selecting another video, tuning to another television channel, tuning to another radio channel, etc.).

Priority levels are assigned to the tuners. This can be done prior to installation time, at installation time, or when the tuner is already installed on the network. The priority levels are used to give a tuner priority over another tuner with respect to changing the broadcast-signal. A tuner with a lower priority level cannot change the broadcast-signal if that broadcast-signal was initiated by another tuner with a higher priority level. A tuner with a higher priority level can change the broadcast-signal if that broadcast-signal was initiated by another tuner with a lower priority level. Tuners with the same priority level can change the broadcast-signal if that broadcast-signal was initiated by a tuner with the same priority level. A tuner can change the broadcast-signal if that broadcast-signal was initiated by the same tuner.

A tuner changes the broadcast-signal by sending a control-signal to the source-tuner, which source-tuner then actually switches from the currently selected broadcast-signal to another broadcast-signal.

Tuners in the network make their presence known to the source-tuner by sending a logon signal to the source-tuner when connected to the network. The logon signal comprises at least the priority level and an identification of the tuner. The source-tuner stores the identification and the priority level in memory.

Alternatively the priority level is assigned by the source-tuner. A priority level does not need to be comprised in the logon signal in this case, or the priority level in the logon signal can be ignored by the source-tuner. The source-tuner can in this alternative assign the priority level in any suitable manner, e.g., by taking into account the order in time of receipt of logon signals, by taking into account predefined priority lists (e.g., based on types of receivers, types of tuners, identification of the tuner, etc.) stored in a memory of the source-tuner.

As described above, the control-signal is sent from the tuner that receives the control-signal to the source-tuner using the network. The control-signal comprises the identification of the tuner and data indicating the requested broadcast-signal. The control-signal is processed by the source-tuner, whereby the priority of the tuner is derived from the identification of the tuner by looking up the identification of the tuner in the memory and finding the matching priority level in the memory. It is also possible that the priority level is comprised in the control-signal. In this case the priority level needs not to be looked up in the memory of the source-tuner. The source-tuner compares the priority level of the tuner with the priority level of the previous tuner that sent a control-signal. This priority level of the previous tuner is also stored in the memory of the source-tuner.

The source-tuner can remove information about the tuners from its memory. Tuners that are not known to the source-tuner, i.e., for which no data is stored in memory, will not be allowed to change the broadcast-signal. Control-signals originating from unknown (not logged-on) tuners will be discarded by the source-tuner. Information about a tuner will be removed from the memory of the source-tuner when the tuner sends a logoff signal to the source-tuner or when the tuner is disconnected from the network, which disconnection can be detected by the source-tuner. It is possible that upon disconnection of an end-receiver from a tuner, the tuner sends a logoff signal to the source-tuner.

The priority level of a tuner can be configured or changed on the tuner. It is possible to have a protection system on a tuner to prevent unauthorized persons to change the priority level of a tuner. Such a protection system is, e.g., password protection, child-lock, and etc.

In case the priority levels are assigned by the source-tuner, it is possible to configure or change priority levels for tuners on the source-tuner.

Many modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A source-tuner comprising:
a receiver for receiving an external broadcast-signal; and
a transmitter for broadcasting an internal broadcast-signal to a network communicatively linked to a tuner; wherein
the source-tuner is adapted to receive a control-signal from the tuner and to select an external broadcast-signal, as the source of the internal broadcast-signal, on the basis of the control-signal received from the tuner.

2. The source-tuner of claim 1 wherein:
the transmitter is adapted to broadcast the internal broadcast-signal to a network communicatively linked to a plurality of said tuners; and
the source-tuner is provided with memory for storing an identification and/or a priority level of at least one of said tuners.

3. The source-tuner of claim 1 wherein the source-tuner is adapted to receive more than one external broadcast-signal and to broadcast more than one internal broadcast-signal on the network.

4. A system comprising:
a source-tuner according to claim 1;
a tuner comprising a control-signal transmitter for transmitting a control-signal to the source-tuner; and
a network communicatively linking the source-tuner and the tuner; said network being capable of transmitting an internal broadcast-signal.

5. The system of claim 4 wherein the control-signal transmitter is adapted to send a control-signal comprising an identification of the tuner associated with the control-signal.

6. The system of claim 4 wherein the control-signal transmitter is adapted to send a control-signal comprising a priority level of the tuner associated with the control-signal.

7. The system of claim 5 wherein:
the source-tuner comprises a status-information generator and status-information transmitter for transmitting said status-information via the network; and
the tuner is adapted to incorporate said status-information into a signal to be sent to an end-receiver communicatively linked thereto.

8. The system of claim 5 comprising a plurality of tuners each having an end-receiver communicatively linked thereto.

9. A method for selecting a broadcast-signal in a system according to claim 5 in which:
a tuner sends a control-signal to the source-tuner; and
the source-tuner receives the control-signal and selects an external broadcast-signal from a plurality of available external broadcast-signals on the basis of the control-signal.

10. The method of claim 9 wherein a priority level is associated with the tuner transmitting the control-signal and the source-tuner does or does not carry out the action of selecting an external broadcast-signal depending upon the priority level of the tuner associated with the control-signal.

11. The method of claim 10 wherein the source-tuner compares the priority level of the tuner transmitting a control-signal with the priority level of a tuner having transmitted a previous control-signal and acts to select an external broadcast-signal only when the priority level of the transmitting tuner is higher, or equal to or higher, than the priority level of the previous tuner.

12. The method of claim 11 wherein the control-signal includes an identification and/or a priority level of the tuner sending the control-signal.

13. The method of claim 10 wherein the source-tuner generates status-information and transmits the status-information via the network; and the tuner receives and forwards the status-information to an end-receiver communicatively linked to it.

14. A tuner comprising:
a receiver for receiving an internal broadcast-signal from a network communicatively linked to a source-tuner;
a tuner-transmitter for transmitting a signal to an end receiver; and
a control-signal transmitter for transmitting a control-signal to the source-tuner via the network.

15. A tuner according to claim 14 further comprising memory for storing a priority level and/or an identification of the tuner.
